(19) United States
(12) Patent Application Publication
(10) Pub. No.: US 2009/0087609 A1
(43) Pub. Date: Apr. 2, 2009

(54) Protection System for a Shipping Container

(76) Inventors: Shigeki Masui, Scarsdale, NY (US); Kenji Furuichi, Elmsford, NY (US)

Correspondence Address: David Chen;Delio and Peterson LLC, 121 Whitney Avenue, New Haven, CT, 06510-1214, US

(21) Appl. No.: 12/193,046

(22) Filed: Aug. 18, 2008

Related U.S. Application Data
(60) Provisional application No. 60/975,607, filed on Sep. 27, 2007.

(51) Int. Cl. B32B 7/06; B32B 7/12

(52) U.S. Cl. 428/41.7; 428/40.1; 428/42.2; 156/60; 156/299

(57) ABSTRACT

The invention relates to a lining for a shipping container of an ocean vessel, which has at least one planar sheet having a generally flat surface; a container for an ocean vessel having at least one inside wall; the at least one planar sheet being in contact with and attached to the at least one inside wall with the generally flat surface facing away from the at least one inside wall; an adhesive placed between the at least one planar sheet and the at least one inside wall for removably attaching the at least one planar sheet without altering the at least one inside wall; and wherein the adhesive is a sole securing mechanism for attaching the at least one planar sheet to the at least one inside wall.

### CROSS-REFERENCE TO RELATED APPLICATIONS

The present application claims the benefit under 35 U.S.C. §119(e) of the U.S. Provisional Patent Application Ser. No. 60/975,607, filed on Sep. 27, 2007, the content of which is incorporated herein by reference.

### FIELD OF THE INVENTION

The invention relates to a protection system for a shipping container.

Transporting scrap metal via ocean vessels is typically a cost effective way of delivering large amounts of metal, where the scrap metal providers or scrap metal receivers usually pay ocean vessel owners or managers to transport the scrap metal. However, since scrap metal is of various shapes and/or sizes, and since scrap metal may be unfinished with sharp edges, damage from the scrap metal to the container may occur, resulting in what could be a significant cost to the scrap metal providers or receivers due to the expense of repairing the container.

Because of the potential damage, some owners of the containers often refuse to transport scrap metal. In addition to the repair costs, the time the container is not usable due to it being repaired may exacerbate the problem.

U.S. Pat. No. 4,420,183 to Sherman seems to relate to a plurality of liner sheets to form an interior wall for a truck. Sherman's liner sheets do not seem to be applicable to the inside walls of a shipping container for transportation on an ocean vessel for protecting the inside walls. In addition, Sherman seems to teach prolonging the life of the liner as opposed to a replaceable liner that is easily applied and removed.

U.S. Pat. No. 5,492,747 to Kemp et al. seems to relate to a liner and sidewall combination for a truck. Kemp does not seem to relate a liner for lining a shipping container for transportation on an ocean vessel, where the lining protects the container as opposed to the content. Kemp also seems to teach prolonging the life of the liner as opposed to a replaceable liner that is easily applied and removed.

U.S. Pat. No. 7,258,391 to Graaff et al. relates to a sidewall assembly for placement on an outside of a trailer and not a liner for the inside the container for protecting the inside of the container.

In addition, Kemp, Graaff, and Sherman appear to employ rivets or other fasteners for securing the respective liners and such rivets or fasteners could damage the container. In the very least, the rivets or fasteners inhibit removal of the liners because tools are needed to loosen them.

U.S. Pat. No. 6,308,850 to Coom et al. discloses a paper, corrugated liner for lining a shipping container for protecting the contents being shipped and does not seem to relate to a smooth liner for protecting the container, where the smooth liner and container protection are opposite to what the reference teaches.

Because some of the art seem to relate to fastening the liner to the vehicle or container in a permanent fashion or in some manner where attachment or removal of the liner results in damage to and/or alteration of the container, it would be difficult to use these systems in a shipping container since the owners or managers of the containers are typically adverse to altering or damaging the containers, particularly since the containers may be used for shipping other items when not being used for scrap metal.

Also, the liners of some of the cited art would not be practical because the liners would need to be removed each time the containers are used for a different purpose unless permanently fastened to the containers. However, making the liners a permanent part of the containers may entail drilling holes into the containers for the fasteners and the fasteners and/or holes may also present an area of rust, especially in the salty air environment of the ocean. In view of the foregoing problems, altering the containers in any way is not typically allowed, even if the liners may arguably enhance the containers or are to be permanently attached to the containers.

Moreover, other art is directed to protecting the content or assembly to the outside of the container, thereby rendering its use limited or negligible for protecting the insides of the container.

What is desired therefore is a lining system for protecting the insides of shipping containers from scrap metal. Another desire is a lining system that is attachable to existing inside walls of the container without altering or damaging the container. A further desire is a lining system that is easily removed along with the scrap metal, and where such removal of the lining system does not damage the container. Yet another desire is a lining system that extends in a continuous fashion over all of the inside walls.

### SUMMARY OF THE INVENTION

It is therefore an object of the invention to provide a protection system to the inside of shipping containers to protect the containers from damage caused by scrap metal.

It is another object to provide a liner that is removably attachable to the inside walls of a shipping container without damaging or altering the container.

Yet another object is a liner that is disposed of in similar fashion as the scrap metal.

These and other objects of the invention are achieved by a lining for a shipping container of an ocean vessel, which has at least one planar sheet having a generally flat surface; a container for an ocean vessel having at least one inside wall; the at least one planar sheet being in contact with and attached to the at least one inside wall with the generally flat surface facing away from the at least one inside wall; an adhesive placed between the at least one planar sheet and the at least one inside wall for removably attaching the at least one planar sheet without altering the at least one inside wall; and wherein the adhesive is a sole securing mechanism for attaching the at least one planar sheet to the at least one inside wall.

In some embodiments, a plurality of planar sheets are used, each being adjacent to one another and each being removably attached to the at least one inside wall with adhesive. In a further embodiment, the adhesive attaches the at least one planar sheet to the at least one inside wall without a rivet, a nail, or other fastener.

In other embodiments, a scrap metal is placed inside the container wherein the at least one planar sheet is between the scrap metal and the at least one inside wall for protecting the container from the scrap metal.

In another aspect of the invention, a method for providing a lining for a shipping container of an ocean vessel includes the steps of Providing at least one planar sheet having a generally flat surface; providing a container of an ocean vessel with at least one inside wall; attaching the at least one planar sheet with the at least one inside wall where the generally flat surface faces away from the at least one inside wall; placing adhesive between the at least one planar sheet and the at least one inside wall for removably attaching the at least one planar sheet metal to the at least one inside wall without altering the at least one inside wall; and wherein the adhesive is a sole securing mechanism for attaching the at least one planar sheet to the at least one inside wall.

In some embodiments, the method also removes the at least one planar sheet contemporaneously with removing a scrap metal from the container. In other embodiments, the method includes attaching a handle to the at least one planar sheet metal for maneuvering the at least one planar sheet into position against the at least one inside wall prior to attachment to the at least one inside wall, attaching the at least one planar sheet to the at least one inside wall with adhesive, and removing the handle from the at least one planar sheet.

In other embodiments, the method includes attaching a plurality of planar sheets to a plurality of inside walls with adhesive, each sheet being adjacent to one another and each being removably attached to the at least one inside wall.

In another embodiment, the method attaches the at least one planar sheet to the at least one inside wall with adhesive and without a rivet, a nail, or other fastener. In yet another embodiment, the method also includes the step of loosening an adhesive bond between the at least one planar sheet and the at least one inside wall for facilitating removal of the at least one planar sheet from the at least one inside wall.

In another aspect of the invention, a lining for a shipping container of an ocean vessel, which has A plurality of planar sheets, each having a generally flat surface; a container for an ocean vessel having at least one inside wall; the plurality of sheets being in contact with and attached to the at least one inside wall; a tape extending from the generally flat surface of each sheet to the at least one inside wall for removably attaching each sheet without altering the at least one inside wall; each sheet is placed adjacent to a next sheet for covering the at least one inside wall with the plurality of planar sheets; and wherein the tape is a sole securing mechanism for attaching the plurality of planar sheets to the at least one inside wall.

### BRIEF DESCRIPTION OF THE DRAWINGS

FIG. 1 depicts the protection system in accordance with the invention.

FIG. 2 depicts an exploded view of the system shown in FIG. 1.

FIG. 3A depicts a cross sectional view taken along line 3A-3A shown in FIG. 1.

FIG. 3B depicts a cross sectional view taken along line 3B-3B shown in FIG. 1.

FIG. 4a more particularly depicts the adhesive placed between the lining and inside wall of the system shown in FIG. 1.

FIG. 4b more particularly depicts magnets placed between the lining and inside wall of the system shown in FIG. 1.

FIG. 4c more particularly depicts magnets placed outside the lining and inside wall of the system shown in FIG. 1.

FIG. 5 depicts suction cups for handling the system shown in FIG. 1.

FIG. 6 depicts typical materials used for providing the system shown in FIG. 1.

FIG. 7 depicts another embodiment of the system shown in FIG. 1.

FIG. 8 depicts a method of providing the system shown in FIG. 1.

### DETAILED DESCRIPTION OF THE INVENTION

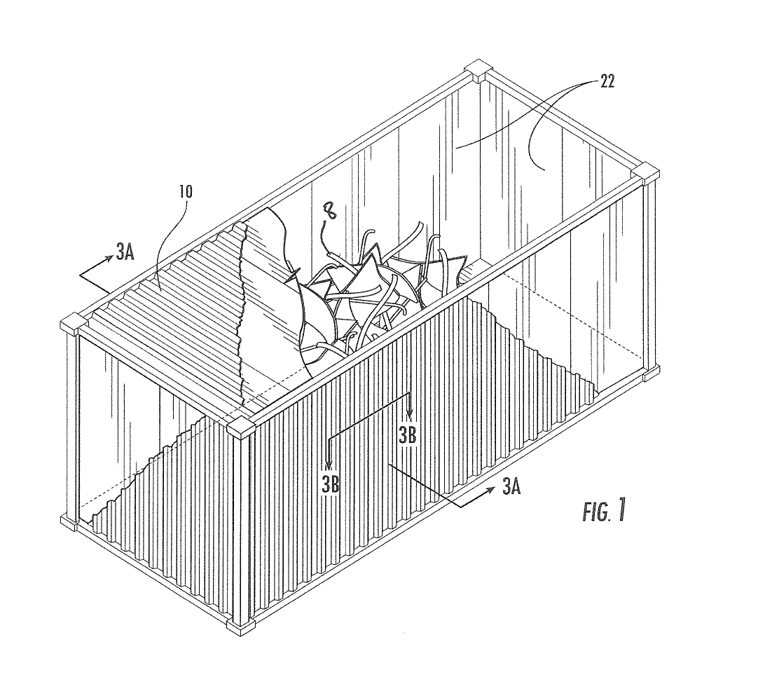

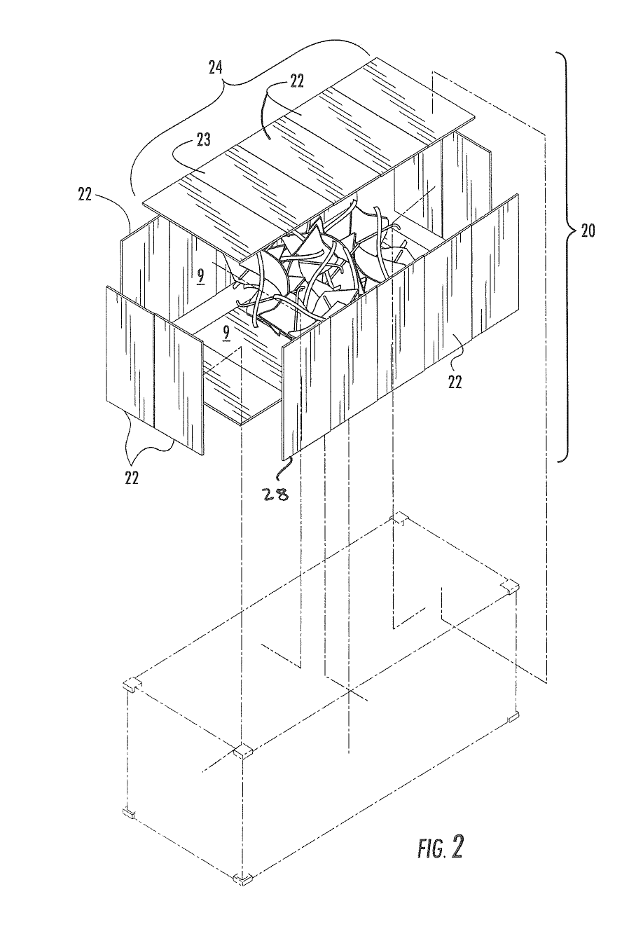

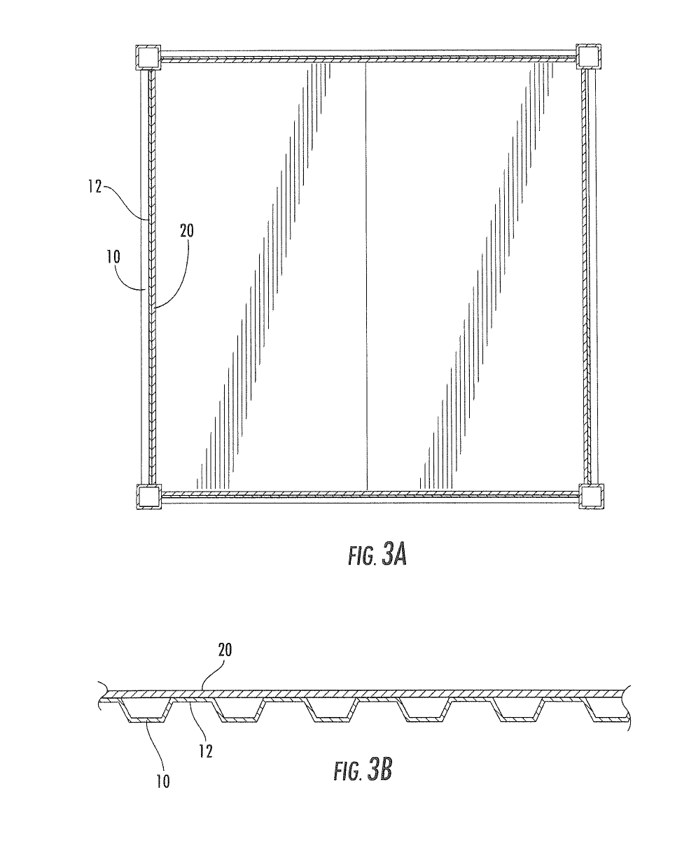

As shown in FIGS. 1-3B, the invention is directed to ocean container protection for steel scrap transportation. The protection system for a container is liner 20 and, in some embodiments, includes at least one planar sheet metal 22 placed on at least one inside wall 12 of ocean container 10. In further embodiments, liner 20 is plurality 24 of sheet metal. In other embodiments, liner 20 is plurality 24 of sheet metal placed over an entire interior of container, or over all inside walls 12, as a protective layer between container 10 and scrap metal 8.

The smoothness of liner 20, or the steel sheets, helps scrap metal 8 slide in and out of container 10, which reduces damage within container 10 during the loading and unloading of scrap metal 8.

At least one planar sheet 22 also reduces contamination to container 10 because it acts as a barrier between any corrosive elements or bacteria on scrap metal 8 from coming in contact with at least one inside wall 12. At the destination, at least one planar sheet 22 is discharged together with scrap metal 8 and all are recycled.

The sheets of metal should be strong enough to protect containers from damage during loading, unloading, and transportation of steel scrap. The size and thickness of the sheets should be optimized so that they are light enough for easy handling. By using equipment such as a suction hand cup, workers are able to install the steel sheets easily and safely in containers. Due to the ease of applying the protection system, a minimum amount of workers, such as 1 or 2 workers, suffices in installing the protection system.

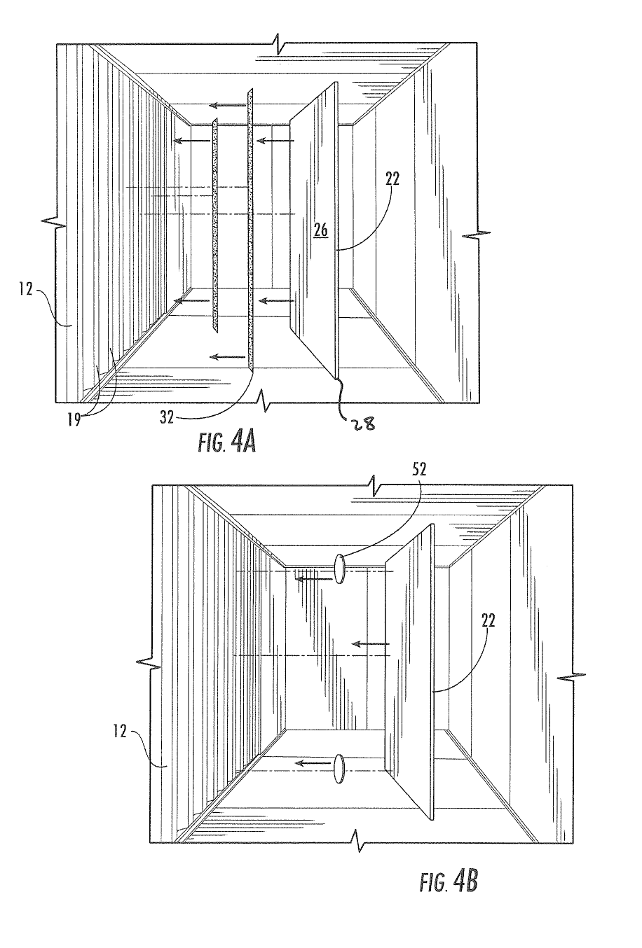

In one embodiment, plurality 24 of sheet metal are removably attached to at least one inside wall 12 by adhesive, which is defined to be glue, tape, or any tacky substance between liner 20 and at least one inside wall 12 in such a way that attachment is achieved without damaging container 10 or at least one inside wall 12. It is important to note no screws, rivets, or other fasteners are used for securing liner 20 to container 10, including at least one inside wall 12, because such fasteners damage or alter the container since a hole is needed in container 10 or wall 12 in order to secure liner 20 to the wall or container. When liner 20 is removed, the holes will then need to be filled or repaired. As shown in FIG. 4a, adhesive 32 is a sole securing mechanism for securing liner 20, or plurality 24 of sheets, to at least one inside wall 12.

Even if the fasteners for securing liner 20 merely dings or bends container 10, this is still considered damage that warrants repairing and, therefore, such fasteners would be prohibited or undesirable. In the very least, the rivets or fasteners inhibit removal of the liners because tools or time are needed to loosen them. This is why a securing mechanism that does not alter or damage container 10 is preferably, such as an adhesive, tape, or glue.

Even if liner 20 is permanently fastened with fasteners to inside container 10, in which case any holes are hidden from view behind liner 20 and/or filled with the fasteners themselves, the holes whether filled or behind liner 20 still present an area for corrosion to thrive, especially the holes that are behind liner 20 and typically away from direct sunlight and therefore prone to remaining moist if wetted. The corrosion problem is exacerbated for a container used on an ocean vessel where the holes are exposed to salt water and/or salt air.

Preferably, adhesive 32 gradually loses its adhesion strength after a certain period so that the steel sheets come off easily and is discarded or recycled together with scrap metal 8 when scrap is unloaded at the destination.

In an optional embodiment, and shown in FIGS. 4b-4c, magnets 52 are used for securing liner 20 to container 10, where liner 20 is placed between magnets 52 and container 10. In some embodiments, magnets 52 are placed between container 10 and liner 20. The magnets are particularly useful for enhanced attachment of liner 20 to container 10. Moreover, the magnets can be used in addition to or instead of adhesive 32. The magnets are also reusable or can be discarded or recycled depending upon the costs of the magnets.

As shown in FIG. 1, liner 20 is any layer between content and container 10. Liner 20 is useful for any application in which the content may damage container 10.

In a more specific embodiment, the content is scrap metal of various shapes and sizes, including having rough, jagged, and otherwise unsafe edges. Container 10 is a typical shipping container used for ocean vessels and is typically corrugated steel, although container 10 can be of any material, such as plastic, wood, and the like. In this embodiment, liner 20 is made of sheet metal having a thickness of approximately 24 gauge.

In another embodiment, liner 20 is sheet metal having a thickness of between approximately 20 and approximately 30 gauge. In a further embodiment, liner 20 is sheet metal having a thickness of between approximately 15 and approximately 35 gauge. In other embodiments, liner 20 is sheet metal having a thickness of between approximately 10 and approximately 40 gauge.

In yet another embodiment, liner 20 is plastic, fiberglass, and the like. This is particularly useful when content 8 is corrosive or has other chemicals that may cause plurality 24 of sheet metal to fail. All that is required is that the material of liner 20 is generally flat, smooth, and sufficiently rigid to resist punctures from the scrap metal yet allow the scrap metal to slide along its generally flat surface without being snagged by the liner and that liner 20 protects or reduces damage to container 10, where damage may be caused by the content scraping and/or bumping against container 10 during transportation of content 8. In some embodiments, liner 20 is smooth relative to inside wall 12 or container 10 for allowing any jagged edges of the content to slide along liner 20 rather than getting caught against inside wall 12, thereby resulting in damage to container 10.

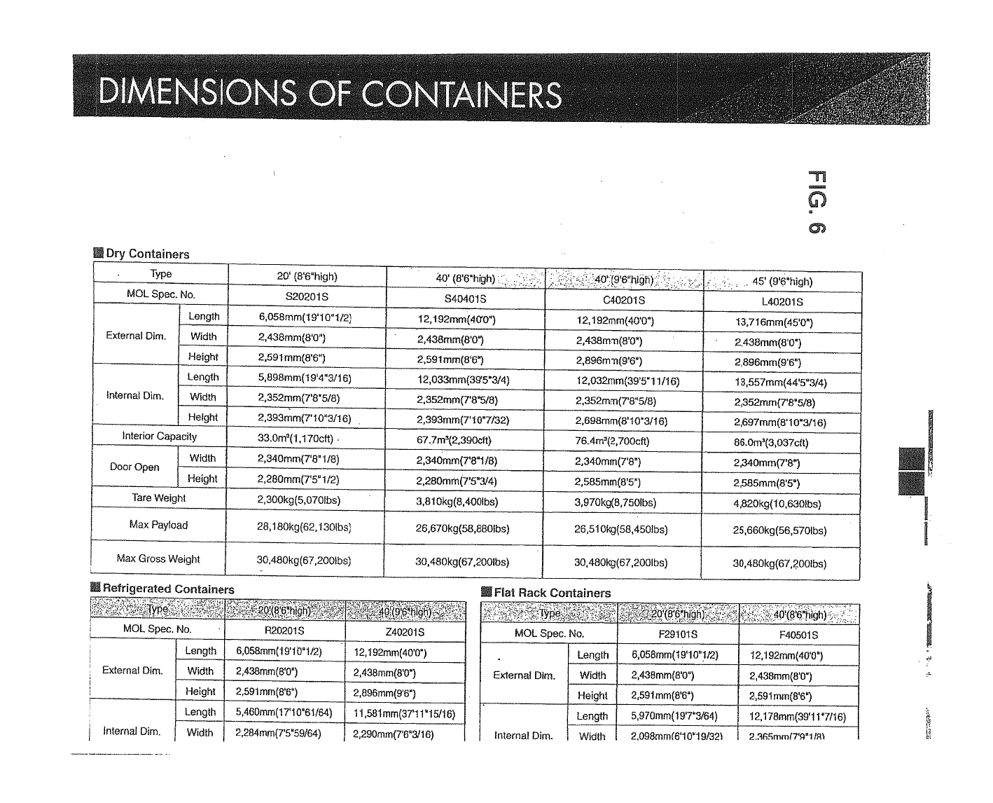

During application of liner 20 to container 10, liner 20 is typically purchased in standard sizes, such as 4 feet×8 feet, and glued or taped to inside wall 12 of container 10. In other embodiments, the size is approximately 60 inches×80 inches. Because container 10 is a large size (see samples of typical sizes in FIG. 6) relative to the size of liner 20, cutting liner 20 is usually not necessary since any extra lengths of sheet metal can simply overlap an adjacent sheet metal. In other words, at least one planar sheet 22 is placed adjacent to a next 23 planar sheet. However, cutting may be done if desired.

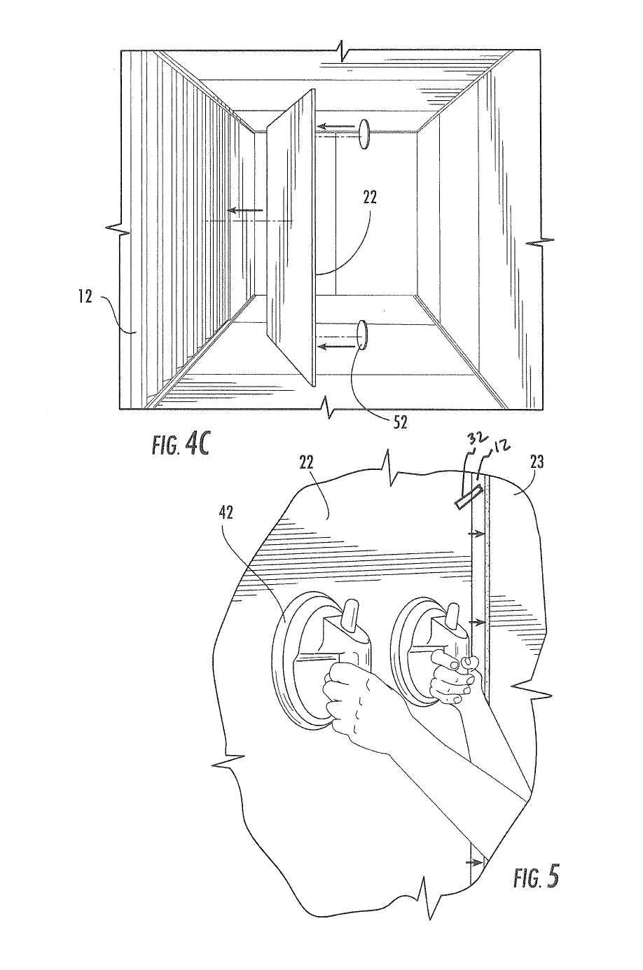

Liner 20 is typically handled with suction cups 42 (FIG. 5), where glue or tape is applied to first side 26 of at least one planar sheet 22 opposite suction cups 42 before affixing liner 20 to inside wall 12(see FIG. 4a). In another embodiment, tape is applied to surface 9 and extends beyond an edge of surface 9 for securement to at least one inside wall 12 or to any part 19 of the corrugated walls. In a further embodiment, tape is applied to two surfaces 9 of two adjacent planar sheets 22, 23. As shown, inside wall 12 is any one of the six interior walls of container 10, which includes the floor, four side walls generally perpendicular to the floor, and top wall. It is understood liner 20 is adhered to at least one of the inside walls. In another embodiment, liner 20 is adhered to all six inside walls. After adhering liner 20 to at least one inside wall 12, content 8 is loaded into container 10, where content 8 includes scrap metal.

It is understood plurality 24 of sheets cover container 10 of any size, such as those shown in FIG. 6, via the butt to butt (see FIG. 5) or overlapping manner described herein. For larger containers, a larger quantity of planar sheets is used whereas smaller containers use a smaller quantity of planar sheets. It is also understood that more than one layer of plurality 24 of sheets is utilized in embodiments where scrap metal 8 is particularly caustic, sharp, or content 8 is otherwise potentially more damaging to container 10 relative to other content, in which case more than one layer of plurality 24 of sheets are used to reduce damage to container 10.

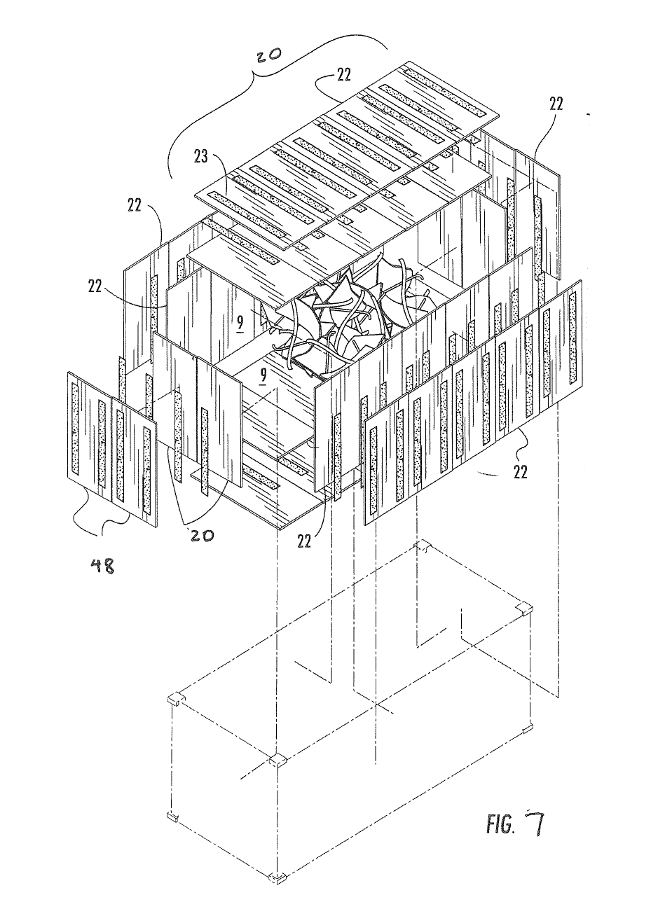

In some of these embodiments as shown in FIG. 7, a first layer 20 is attached to the at least one inside wall 12 in the same manner as described above and a next layer 48 is applied on top of or attached to the first layer 20. FIG. 7 depicts such a relationship where first layer 20 of plurality of sheets is directly attached to container 10 and second layer 48 is attached directly to first layer 20. Second layer 48 has the same limitations as first layer 20, which is the same as liner 20.

In another embodiment, content 8 is used to secure at least one planar sheet metal 22 to at least one inside wall 12 without adhesive 32. In some of these embodiments, plurality 24 of sheet metal lack any adhesive 32 for being secured to any of the interior walls.

In these embodiments lacking adhesive 32 for securing sheet 22 to one or more walls, sheet 22 is placed between content 8 and at least one inside wall 12 and where bottom 28 of vertically placed sheet 22 rests upon the container floor. In this manner, sheet 22 is inhibited from moving away from wall 12 due to content 8 and sheet 22 is inhibited from moving parallel to wall 12 due to friction of bottom edge 28 upon the floor.

In these embodiments, method 100 includes placing sheet 22 contemporaneously with placing content 8 so that content 8 inhibits sheet 22 from falling. It is understood that content 8 need not fill entire container 10 for this embodiment to operate properly. In most applications, container 10 need only be approximately ⅓ to ½ full, which is sufficient for inhibiting sheets 24 from falling over.

In the event container 10 is less than full, sheet 22 may bend or flex due to the lack of support near an upper end of sheet 22 since content 8 is located on or near the floor of container 10. However, bending or flexing is not indicative of failure because the invention is merely to provide a buffer or separation of content 8 from container 10. Therefore, so long as sheet 22 is between container 10 and content 8, bending or flexing is not problematic, even if sheet 22 is permanently bent. Should content 8 shift during transport, the bending or flexing is still not problematic since content 8 pressing against a bent or flexed part will still be inhibited from contacting container 10.

In the embodiment where the content is scrap metal, and after transporting the content to its destination, the scrap metal is emptied along with liner 20 for recycling. In this fashion, nothing is wasted. This is also useful in the event liner 20 is no longer needed and the recipient of the content need not find or pay a trash hauler to discard liner 20. In addition, since liner 20 is adhered using adhesive 32, tape, or glue, such adhesion loses its effectiveness over time and, therefore, liner 20 is less difficult to remove after the content has been transported as opposed to prior to being transported.

Due to the standard 4 foot×8 foot or 60 inch×80 inch size of the sheet metal, and even if at least one planar sheet 22 becomes loose during transportation, it usually does not present a problem where container 10 will be damaged since the standard size sheet metal will not likely slip out of position due to its size relative to at least one inside wall 12, particularly if container 10 is near full capacity, in which case there is less room for at least one sheet 22 to shift out of place.

As shown, liner 20 is plurality 24 of sheet metal, which reduces snagging between scrap metal 8 and liner 20. Moreover, plurality 24 of sheet metal reduces damage to at least one inside wall 12 because any bumps, dings, or scrapes caused by scrap metal 8 that would otherwise be against at least one inside wall 12 is now absorbed by liner 20. In addition to protecting at least one inside wall 12 from mechanical damage, since scraping is reduced, any paint on at least one inside wall 12 is protected as well by liner 20 being a buffer between the paint and scrap metal 8.

In some embodiments, in addition to the above protection to at least one inside wall 12 and/or paint from liner 20, liner 20 permits scrap metal 8 to be discharged from container 10 in a quicker fashion than a container without liner 20. This is because the general flatness or smoothness of liner 20 reduces snagging from scrap metal 8 against at least one inside wall 12, whereby scrap metal 8 may be delayed from exiting container 10 due to it being caught against at least one inside wall 12. In other embodiments, the relative slickness of surface 9 of liner 20 versus at least one inside wall 12 further facilitates the exiting of scrap metal 8, particularly if at least one inside wall 12 is corrugated.

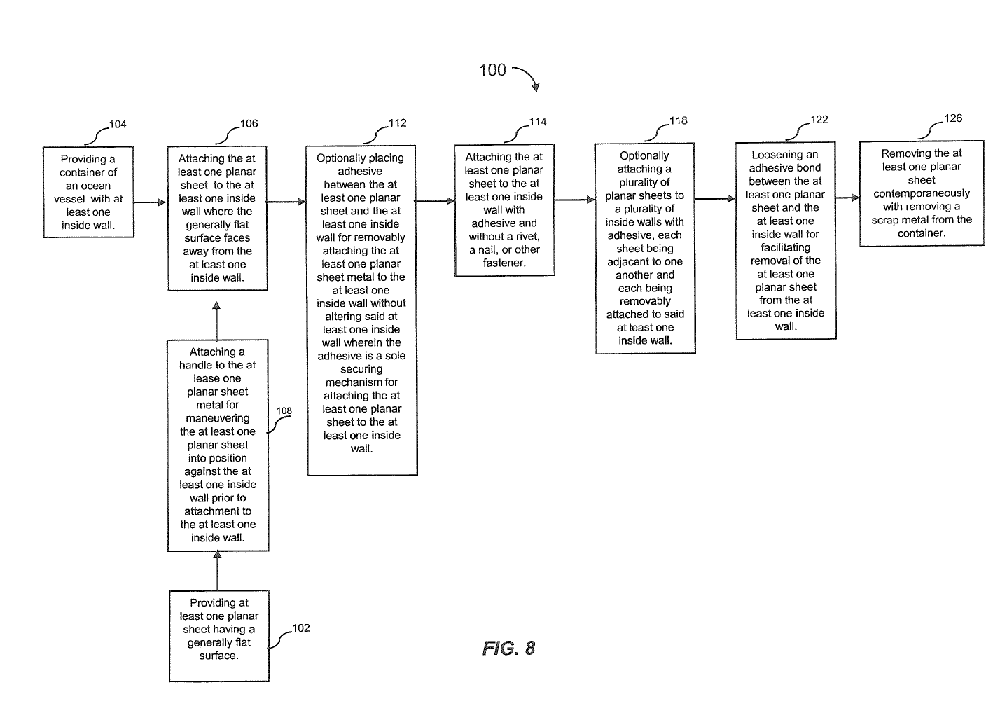

FIG. 8 depicts method 100 for providing a lining for a shipping container of an ocean vessel, including the steps of Providing 102 at least one planar sheet having a generally flat surface, providing 104 a container of an ocean vessel with at least one inside wall, attaching 106 the at least one planar sheet with the at least one inside wall where the generally flat surface faces away from the least one inside wall, and placing 112 adhesive between the at least one planar sheet and the at least one inside wall for removably attaching the at least one planar sheet metal to the at least one inside wall without altering the at least one inside wall, wherein the adhesive is a sole securing mechanism for attaching the at least one planar sheet to the at least one inside wall.

In a further embodiment, method 100 attaches 114 the at least one planar sheet to the at least one inside wall with adhesive and without a rivet, a nail, or other fastener.

In some embodiments, method 100 attaches 108 a handle to the at least one planar sheet metal for maneuvering the at least one planar sheet into position against the at least one inside wall prior to attachment to the at least one inside wall. Subsequently, method 100 attaches 106 the at least one planar sheet to the at least one inside wall with adhesive and removes the handle from the at least one planar sheet.

In other embodiments, the method recites the step of attaching 1 18 a plurality of planar sheets to a plurality of inside walls with adhesive, each sheet being adjacent to one another and each being removably attached to the at least one inside wall.

In some embodiments, method 100 loosens 122 an adhesive bond between the at least one planar sheet and the at least one inside wall for facilitating removal of the at least one planar sheet from the at least one inside wall.

At the recipient's destination, method 100 includes removing 126 the at least one planar sheet contemporaneously with removing a scrap metal from the container.

What is claimed is:

1. A lining for a shipping container of an ocean vessel, comprising:
at least one planar sheet having a generally flat surface;
a container for an ocean vessel having at least one inside wall; said at least one planar sheet being in contact with and attached to said at least one inside wall with said generally flat surface facing away from said at least one inside wall;
an adhesive placed between said at least one planar sheet and said at least one inside wall for removably attaching said at least one planar sheet without altering said at least one inside wall; and
wherein said adhesive is a sole securing mechanism for attaching said at least one planar sheet to said at least one inside wall.

2. The lining according to claim 1, further comprising a plurality of planar sheets, each being adjacent to one another and each being removably attached to said at least one inside wall with adhesive.

3. The lining according to claim 1, wherein said adhesive attaches said at least one planar sheet to said at least one inside wall without a rivet, a nail, or other fastener.

4. The lining according to claim 1, further comprising a scrap metal placed inside said container wherein said at least one planar sheet is between said scrap metal and said at least one inside wall for protecting the container from said scrap metal.

5. A method for providing a lining for a shipping container of an ocean vessel, comprising the steps of:
providing at least one planar sheet having a generally flat surface;
providing a container of an ocean vessel with at least one inside wall;
attaching the at least one planar sheet with the at least one inside wall where the generally flat surface faces away from the at least one inside wall;
placing adhesive between the at least one planar sheet and the at least one inside wall for removably attaching the at least one planar sheet metal to the at least one inside wall without altering said at least one inside wall; and
wherein the adhesive is a sole securing mechanism for attaching the at least one planar sheet to the at least one inside wall.

6. The method according to claim 5, further comprising the step of removing the at least one planar sheet contemporaneously with removing a scrap metal from the container.

7. The method according to claim 5, further comprising the step of attaching a handle to the at least one planar sheet metal for maneuvering the at least one planar sheet into position against the at least one inside wall prior to attachment to the at least one inside wall, attaching the at least one planar sheet to the at least one inside wall with adhesive, and removing the handle from the at least one planar sheet.

8. The method according to claim 5, further comprising the step of attaching a plurality of planar sheets to a plurality of inside walls with adhesive, each sheet being adjacent to one another and each being removably attached to the at least one inside wall.

9. The method according to claim 5, further comprising the step of attaching the at least one planar sheet to the at least one inside wall with adhesive and without a rivet, a nail, or other fastener.

10. The method according to claim 5, further comprising the step of loosening an adhesive bond between the at least one planar sheet and the at least one inside wall for facilitating removal of the at least one planar sheet from the at least one inside wall.

11. A lining for a shipping container of an ocean vessel, comprising:
a plurality of planar sheets, each having a generally flat surface;
a container for an ocean vessel having at least one inside wall; said plurality of sheets being in contact with said at least one inside wall;
scrap metal placed within said container and wherein said plurality of planar sheets are between said scrap metal and said at least one inside wall;
each sheet is placed adjacent to a next sheet for covering said at least one inside wall with said plurality of planar sheets; and
wherein said scrap metal facilitates placement of said plurality of planar sheets against said at least one inside wall.

12. The lining according to claim 11, further comprising a tape extending from said generally flat surface of each sheet to said at least one inside wall for removably attaching each sheet without altering said at least one inside wall.
